(19) United States
(12) Patent Application Publication
(10) Pub. No.: US 2025/0225534 A1
(43) Pub. Date: Jul. 10, 2025

(54) SYSTEMS AND METHODS FOR BENEFICIAL OWNERSHIP INFORMATION REPORTING AND MANAGEMENT

(71) Applicant: Secure Compliance, LLC, Rapid City, SD (US)

(72) Inventors: Paul Freidel, Rapid City, SD (US); Timothy Freidel, Algonquin, IL (US)

(73) Assignee: Secure Compliance, LLC, Rapid City, SD (US)

(21) Appl. No.: 19/014,027

(22) Filed: Jan. 8, 2025

Related U.S. Application Data
(60) Provisional application No. 63/618,596, filed on Jan. 8, 2024.

(51) Int. Cl. G06Q 30/018

(52) U.S. Cl. CPC G06Q 30/018

(57) ABSTRACT

A computer implemented method and system for Beneficial Ownership Information (BOI) reporting with Financial Crime Enforcement Network (FinCEN) is disclosed. A cloud-based system for managing, collecting and filing one or more types of BOI data for a business entity and accessing the cloud-based system with a computer system, displaying on a screen of the computer system one or more webpages of the cloud-based system, and executing with the computer system the cloud-based system processes of: receiving registration details for the business entity from a representative of the business entity; electing a management protocol for the one or more types of BOI data; querying for the one or more types of BOI data via a plurality of data input fields having a corresponding BOI data query for collecting a set of business entity details pertaining to the business entity; preparing a BOI report; and filing the BOI report with FinCEN.

### CROSS-REFERENCE TO RELATED APPLICATIONS

This application claims priority under 35 U.S.C. § 119 to provisional application Ser. No. 63/618,596 filed Jan. 8, 2024, which is incorporated by reference in their entirety.

### FIELD OF THE DISCLOSURE

The present disclosure relates to federal compliance reporting under the Corporate Transparency Act (CTA). More particularly, but not exclusively, the present disclosure relates to Systems and methods for managing, collecting, and filing Beneficial Ownership Information (BOI) with Financial Crime Enforcement Network (FinCEN).

### BACKGROUND

Prior solutions in this field have been inadequate in simplifying the process of managing, collecting, and filing Beneficial Ownership Information (BOI) reports with the Financial Crimes Enforcement Network (FinCEN). The existing systems often require extensive manual input and are not user-friendly, especially for individuals with limited expertise in compliance. There is not a mechanism that allows business owners and their professionals to work together through the compliance process. Furthermore, current solutions do not provide professionals with the freedom to shift data ownership, billing, and administration to their clients.

Therefore, what is needed is an innovative approach to streamline the BOI reporting process by offering a user-friendly platform that guides users through compliance procedures, ensuring rapid submission of BOI reports. The solution is adaptable for both professionals assisting clients and business owners managing their reporting obligations independently. Depending on what each client needs, professionals will have the option to shift data ownership, billing, and administration to their clients—as professionals are taking the stance of not wanting to get involved in the new reporting requirement.

### SUMMARY

Therefore, it is a primary object, feature, or advantage of the present disclosure to improve over the state of the art.

It is a further object, feature, or advantage of the present disclosure to provide professionals with systems and methods for Beneficial Ownership Information (BOI) management, collection, and filing with the Financial Crimes Enforcement Network (FinCEN).

It is a still further object, feature, or advantage of the present disclosure to provide clients and business owners with systems and methods for BOI management, collection, and filing with FinCEN.

Another object, feature, or advantage is to provide systems and methods for BOI reporting that include the ability to transfer BOI data ownership, billing, and administration to another entity or individual, such as an owner or company applicant with BOI reporting obligations.

Yet another object, feature, or advantage is to provide systems and methods for professionals and business owners with various pathways and management tools for BOI reporting.

Still another object, feature, or advantage is to provide systems and methods for BOI reporting that provide company applicants and business owners, including their professional service providers, with maximum flexibility in managing the ongoing reporting requirements mandated by the Corporate Transparency Act (CTA).

At least one other object, feature, or advantage is to provide systems and methods for BOI reporting that include secure one-way BOI data collection without requiring authentication or setting up an account to prevent data leaks and from being compromised.

Yet another object, feature, or advantage is to provide systems and methods for BOI reporting that provide tools for data collection from business owners and company applicants based on information available to professionals.

Other objects, features, or advantages provide systems and methods with tools for professionals and industry companies in the business of forming and managing reporting companies to white label BOI reporting platforms, tools, and correspondence.

Still other objects, features, or advantages provide cloud-based software systems and methods for BOI reporting to facilitate, simplify, and streamline data management, collection, and filing with FinCEN.

In at least one aspect of the present disclosure, a computer implemented method for Beneficial Ownership Information (BOI) reporting with Financial Crimes Enforcement Network (FinCEN) is disclosed. The method includes, for example, such steps as providing a cloud-based system for managing, collecting and filing one or more types of BOI data for a business entity and accessing the cloud-based system with a computer system, displaying on a screen of the computer system one or more webpages of the cloud-based system, and executing with the computer system the cloud-based system processes of: receiving registration details for the business entity from a representative of the business entity; electing a management protocol for the one or more types of BOI data from a set of management elections; querying for the one or more types of BOI data via a plurality of data input fields having a corresponding BOI data query for collecting a set of business entity details from the representative pertaining to the business entity; optionally transferring the management protocol from one representative of the business entity to another representative of the business entity; preparing a BOI report (Step 212, FIG. 10; Step 226, FIG. 11); and filing the BOI report with FinCEN (Step 214, FIG. 10; Step 228, FIG. 11).

In at least one other aspect of the present disclosure, a computer implemented system for Beneficial Ownership Information (BOI) reporting with Financial Crimes Enforcement Network (FinCEN) is disclosed. The system includes a cloud-based system for managing, collecting and filing one or more types of BOI data for a business entity and a tangible computer readable medium comprising computer executable instructions tangibly embodied thereon which, when executed, cause a processor of a computer system to access the cloud-based system with the computer system, display on a screen of the computer system one or more webpages of the cloud-based system, and execute with the computer system the cloud-based system of: a registration webpage for receiving registration details for the business entity from a representative of the business entity; an ownership management webpage for electing a management protocol for the one or more types of BOI data from a set of management elections, wherein the ownership page includes an option for transferring the management protocol from the representative of the business entity to another representative of the business entity; one or more BOI data query webpages comprising a plurality of data input fields having a corresponding BOI data query for collecting a set of business entity details pertaining to the business entity; and one or more BOI report submission webpages for filing the BOI report with FinCEN.

Yet in another aspect of the present disclosure a tangible computer readable storage medium comprising computer executable instructions tangibly embodied thereon which, when executed, cause a processor of a computer system to access a cloud-based system with the computer system, display on a screen of the computer system one or more webpages of the cloud-based system, and execute with the computer system the cloud-based system of managing, collecting and filing one or more types of BOI data for a business entity is disclosed. The method includes, for example, such steps as receiving registration details for the business entity from a representative of the business entity; electing a management protocol for the one or more types of BOI data from a set of management elections; querying for the one or more types of BOI data via a plurality of data input fields having a corresponding BOI data query for collecting a set of business entity details pertaining to the business entity; preparing a BOI report; and filing the BOI report with FinCEN.

One or more of these and/or other objects, features, or advantages of the present disclosure will become apparent from the specification and claims that follow. No single embodiment need provide each and every object, feature, or advantage. Different embodiments may have different objects, features, or advantages. Therefore, the present disclosure is not to be limited to or by any objects, features, or advantages stated herein.

### BRIEF DESCRIPTION OF THE DRAWINGS

Illustrated embodiments of the disclosure are described in detail below with reference to the attached drawing figures, which are incorporated by reference herein.

FIG. 1 is a pictorial representation providing a Beneficial Ownership Information (BOI) reporting systems and methods in accordance with an exemplary aspect of the present disclosure.

FIG. 2 is another pictorial representation illustrating aspects of a BOI reporting system and method in accordance with an exemplary aspect of the present disclosure.

FIG. 3 is another pictorial representation illustrating aspects of a BOI reporting system and method in accordance with an exemplary aspect of the present disclosure.

FIG. 4 is another pictorial representation illustrating aspects of a BOI reporting system and method in accordance with an exemplary aspect of the present disclosure.

FIG. 5 is a pictorial representation illustrating aspects of a BOI data collection system and method in accordance with an exemplary aspect of the present disclosure.

FIG. 6 is another pictorial representation illustrating aspects of a BOI reporting system and method in accordance with an exemplary aspect of the present disclosure.

FIGS. 7-9 are pictorial representations illustrating screenshots of BOI reporting systems and methods in accordance with exemplary aspects of the present disclosure.

FIGS. 10-11 are pictorial representations providing flow diagrams of BOI reporting methods in accordance with an exemplary aspect of the present disclosure.

### DETAILED DESCRIPTION

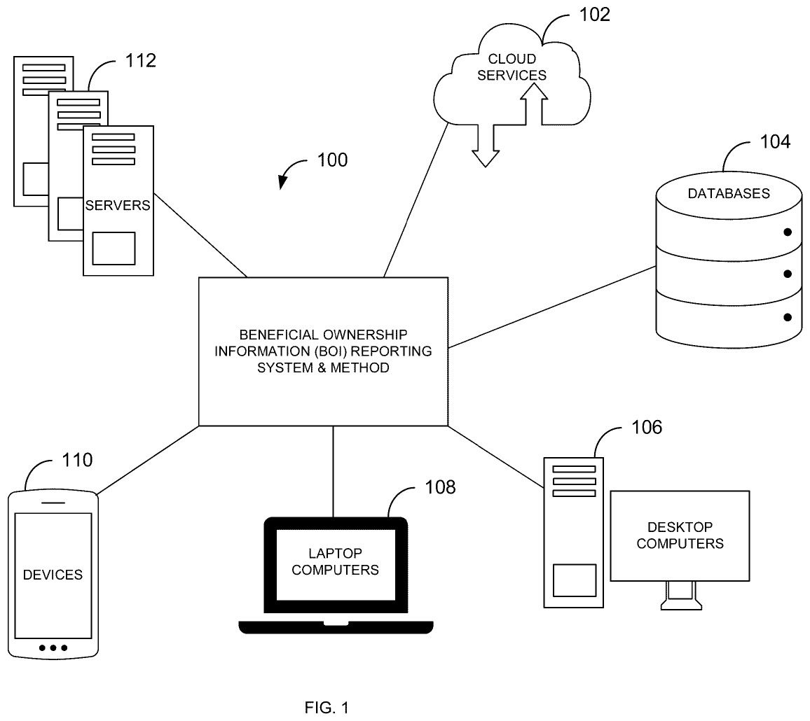

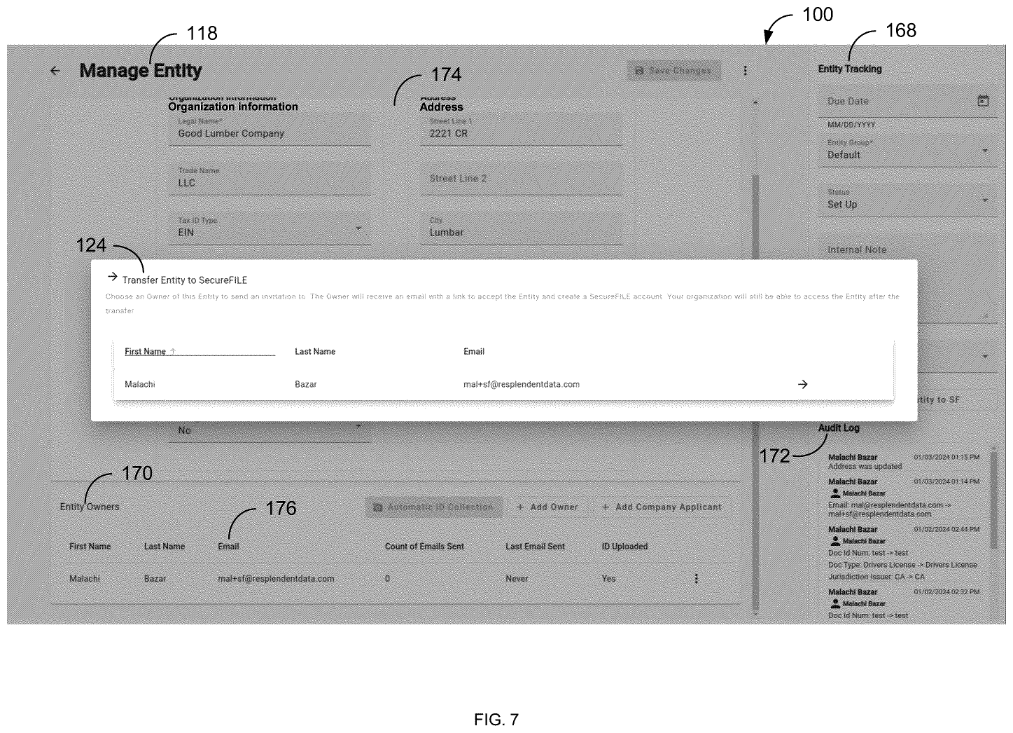

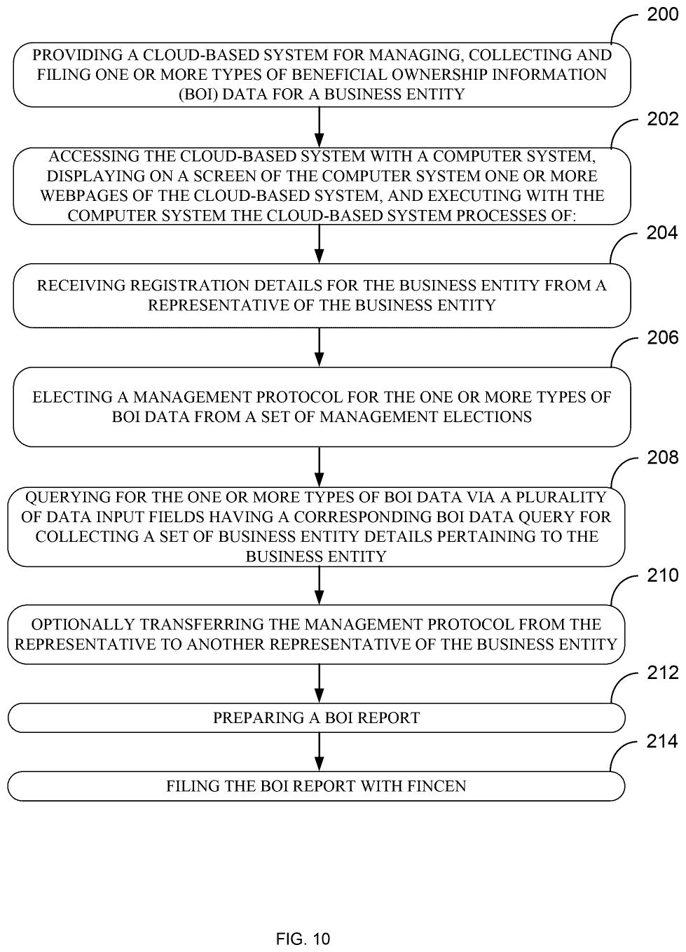

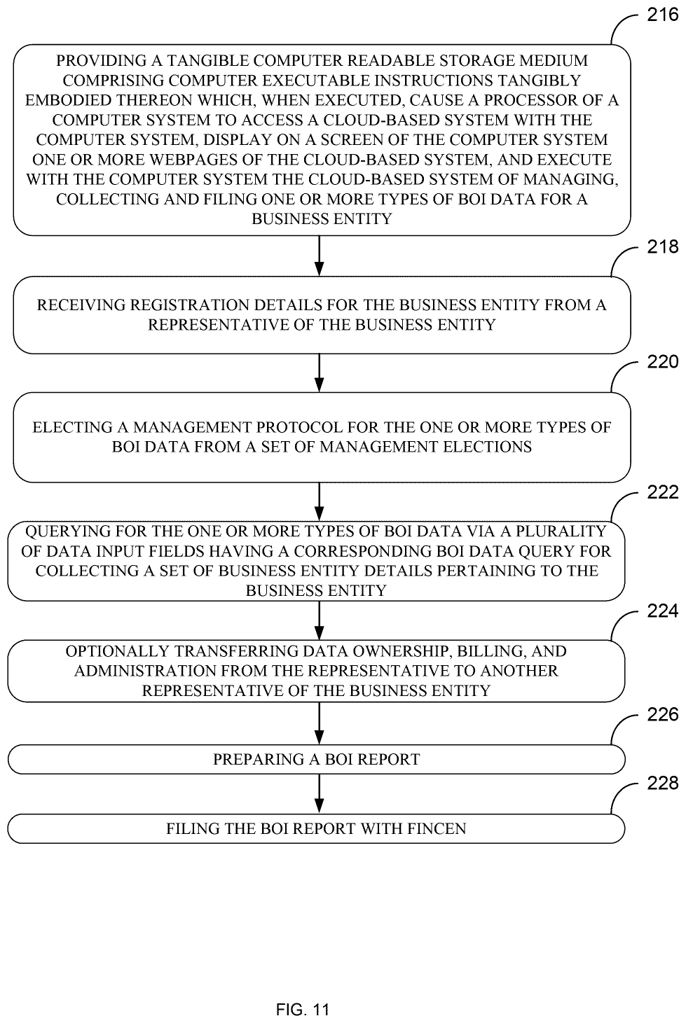

FIGS. 1-6 provide various pictorial illustrations for exemplary aspects of Beneficial Ownership Information (BOI) reporting systems and methods in accordance with the objects, features, and advantages of the present disclosure. FIGS. 7-9 provide various pictorial illustrations in the form of screenshots of a BOI reporting systems and methods in accordance with the objects, features, and advantages of the present disclosure. FIGS. 10-11 provide various flowchart diagrams of BOI reporting methods in accordance with the objects, features, and advantages of the present disclosure.

The present disclosure contemplates many different processes and varying arrangements, methods and systems for BOI reporting and its commercialization applications and use. Representative applications of methods and systems for BOI reporting are described in this section as well as processes and digital architectures for accomplishing the same. These examples are provided solely to add context and aid in understanding the described aspects of the disclosure. It will thus be apparent to one skilled in the art that the described aspects of the disclosure may be practiced without some and/or all of these specific details. In other instances, well known process steps have not been described in detail in order to avoid unnecessarily obscuring the described aspects. Other applications are possible, such that the following examples should not be taken as limiting.

In the following detailed description, references are made to the accompanying drawings, which form a part of the description and show, by way of illustration, specific aspects in accordance with the methods and systems of the present disclosure. Although aspects of the disclosure are described in sufficient detail to enable one skilled in the art to practice the described aspects, it is understood that these examples are not limiting; other aspects may be used, and changes may be made without departing from the spirit and scope of the described aspects of the disclosure.

It will also be understood that, although the terms first, second, next, lastly, etc. may be used herein to describe various elements, these elements should not be limited by such terms. These terms are only used to distinguish one element from another. For example, a first step could be termed a second step, and, similarly, a second step could be termed a first step, without departing from the spirit and scope of the present disclosure.

The terminology used herein is for the purpose of describing particular aspects of the disclosure only and is not intended to be limiting of the present disclosure. As used in the description of the disclosure and the appended claims, the singular forms “a”, “an” and “the” are intended to include the plural forms as well, unless the context clearly indicates otherwise. By way of example only, while the singular form of numerous components and steps are described in various aspects of the disclosure herein, it will be apparent that more than one of such components and/or steps can be used to accomplish the same. It will also be understood that the term “and/or” as used herein refers to and encompasses any and all possible combinations of one or more of the associated listed items. It will be further understood that the terms “comprises” and/or “comprising,” when used in this specification, specify the presence of stated features, functions, integers, steps, operations, elements, and/or components, but do not preclude the presence and/or addition of one or more other features, integers, steps, operations, elements, components, and/or groups thereof. It will be similarly understood that the terms “including,” “include,” “includes”, “such as” and the like, when used in this specification, are intended to be exemplary and should be construed as including, but not be limited to, all items recited thereafter. As used herein, the term “if” may be construed to mean “when” or “upon” or “in response to determining” or “in response to detecting,” depending on the context.

The term “representative” of the business entity may include: (1) a beneficial owner of the business entity (e.g., person(s) having 25% ownership or substantial control); (2) a company applicant (e.g., person(s) involved in the formation of the business entity—only required for post Jan. 1, 2024 formed entities); or (3) some other type of representative (e.g., anyone using the BOI reporting systems and methods 100 of the present invention) that is not a representative from either groups (1) or (2). A “user” of system 100 is a representative of the business entity for purposes of the present disclosure.

BOI reporting systems, 100 in FIGS. 1-9, and methods, Steps 200-228 in FIGS. 10-11 (collectively, BIO reporting systems and methods 100), of the present disclosure offer, in at least one aspect, cloud-based software solutions to simplify and streamline Beneficial Ownership Information (BOI) reporting under the Corporate Transparency Act (CTA), aiding professionals and business owners in managing, collecting, and filing required documentation with the Financial Crimes Enforcement Network (FinCEN) (Step 200, FIG. 10). BOI reporting systems and methods 100 of the present disclosure also provide specialized software solutions aimed at assisting representatives such as professional service providers, company applicants and business owners to fulfill Beneficial Ownership Information (BOI) reporting requirements under the Corporate Transparency Act (CTA) (Step 216, FIG. 11). BOI reporting systems and methods 100 of the present disclosure are designed to simplify and streamline the process of managing, collecting, and filing necessary documentation with Financial Crimes Enforcement Network (FinCEN). This includes guiding users through the compliance process, regardless of their level of expertise, and ensuring rapid submission of BOI reports filed by applicable entities, such as a reporting company or owner. Whether professionals will help guide their clients through the reporting obligations or the business owner or some other representative of the business entity will do the process independently, the BOI reporting systems and methods 100 of the present disclosure support all approaches. By leveraging cloud-based technology and innovative management tools, the BOI reporting systems and methods 100 of the present disclosure focus on making FinCEN compliance more accessible and efficient for reporting business owners.

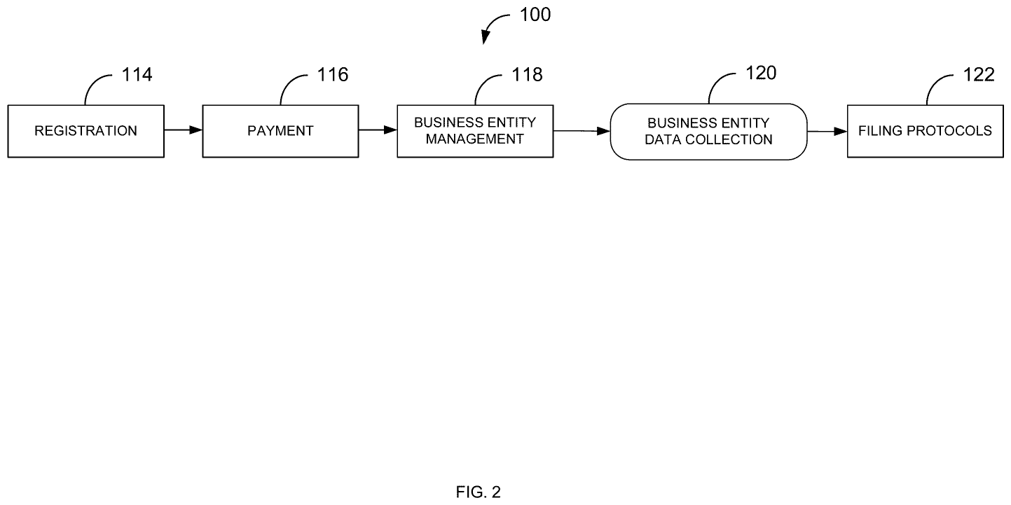

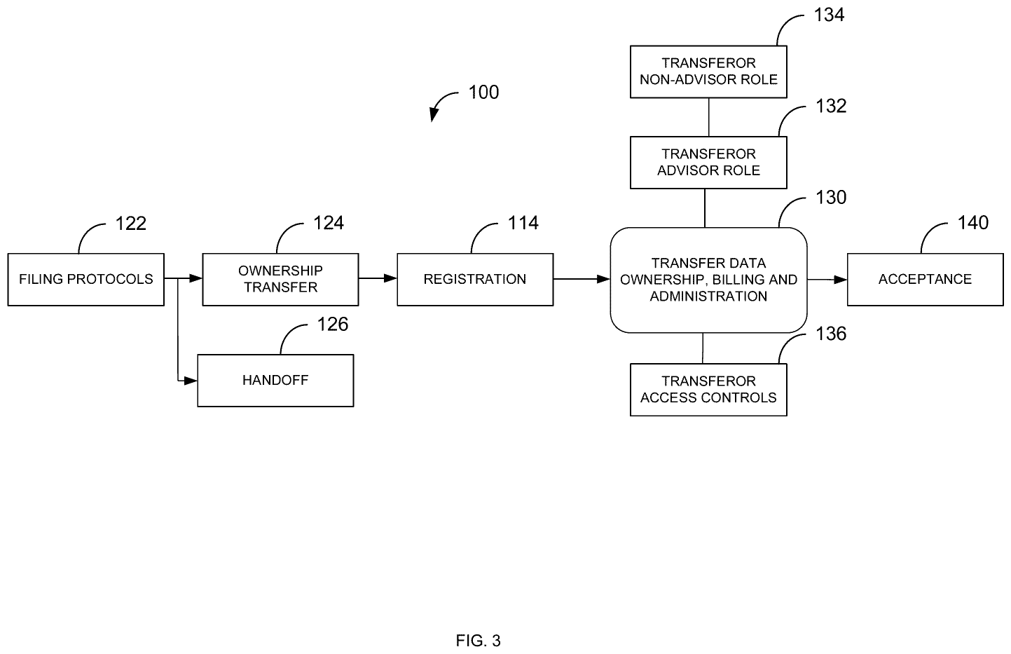

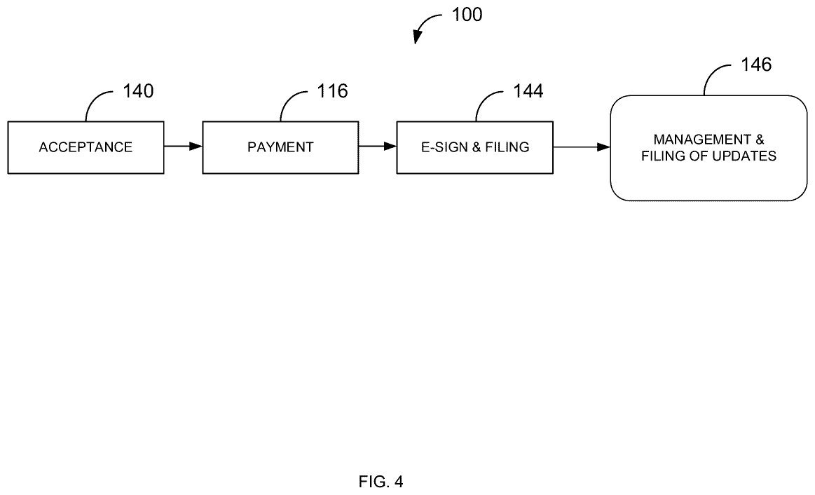

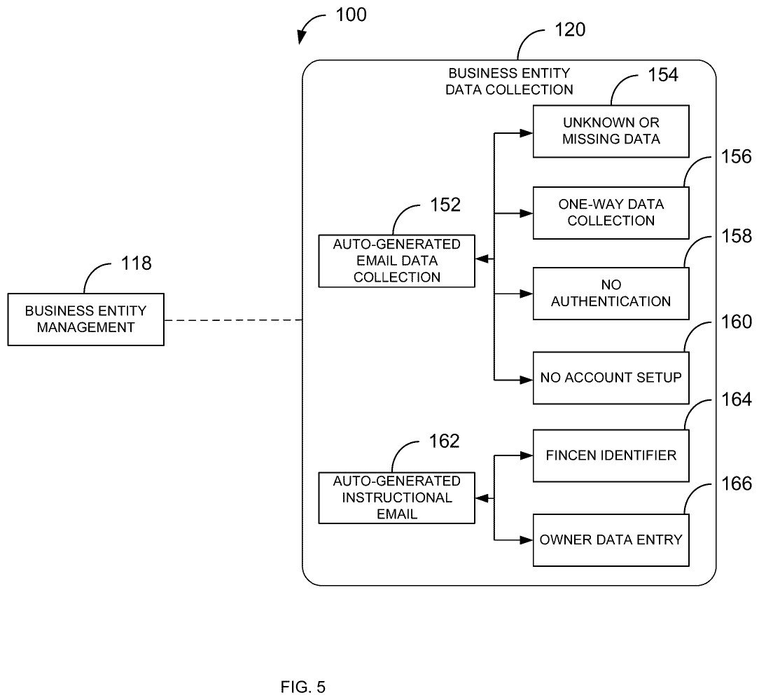

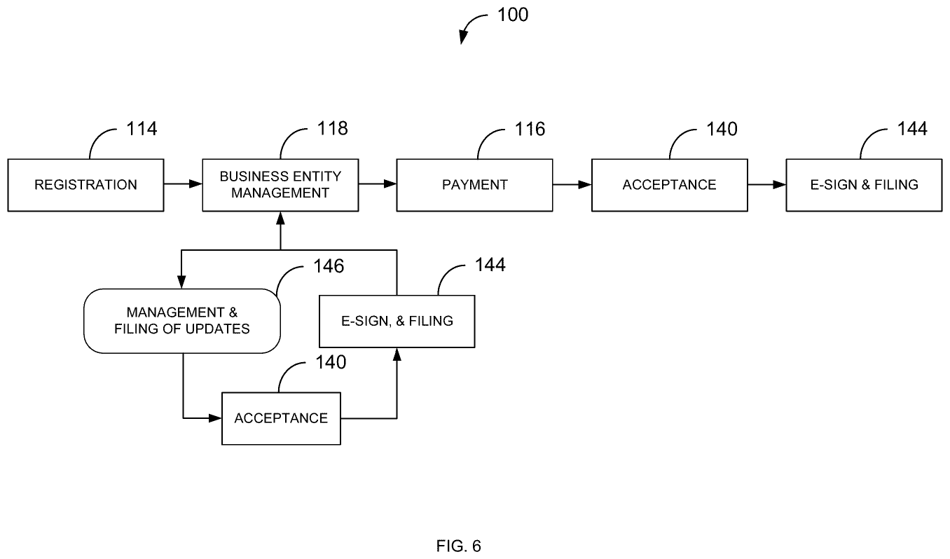

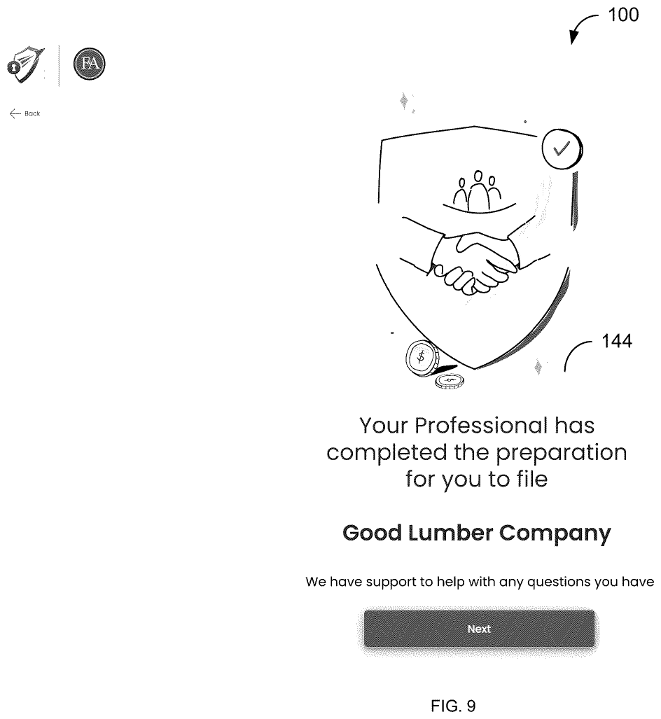

FIGS. 1-11 provide pictorial representations for various aspects of systems and methods for Beneficial Ownership Information (BOI) reporting of the present disclosure. In at least one instance, as shown in FIGS. 1-6, the present disclosure includes cloud-based systems and methods for BOI reporting. For example, a tangible computer readable storage medium having computer executable instructions tangibly embodied thereon which, when executed, cause a processor of a computer system to access the cloud-based systems and methods with the computer system, display on a screen of the computer system one or more webpages (FIGS. 7-9) of the cloud-based system, and execute with the computer system the cloud-based system of managing, collecting and filing one or more types of BOI data for an owner of a business (collectively using one or more of cloud services 102, databases 104, desktop 106 and laptop 108 computers, electronic devices 110, servers 112, and other computer and cloud-based devices/systems). Accessing the cloud-based system 100 (FIG. 1) with a computer system (FIGS. 1-6) on a computer 106, 108 or electronic device 110, displaying on a screen of the computer system (e.g., computer 106, 108, or electronic device 110) one or more webpages (Step 202, FIG. 10) of the cloud-based system (FIGS. 7-9), and executing with the computer system the cloud-based system processes (FIGS. 10-11) may include, for example, receiving registration 114 details (FIGS. 2-3 & 6; Step 204, FIG. 10; Step 218, FIG. 11), as shown in FIGS. 2-3 and 6-7, for the owner of the business or a company applicant, such as, for example, a first and last name, phone number, email address, and other contact information such as a physical/mailing address(es) 170. A payment processing service 116 (FIGS. 2 & 4) provides, in at least one instance of the disclosure, access to and use of the BOI reporting systems and methods 100 (see, for example, FIGS. 10-11) using one or more web applications accessed via an electronic device 110 or computers 106, 108 (FIG. 1). A set of management elections 118 are provided, such as owner (business owner) management election or business entity (company applicant) management election for electing a management protocol (Step 206, FIG. 10; Step 220, FIG. 11) for the one or more types of BOI data obtained by the systems and methods for business entity data collection 120 (FIG. 2). Data collection via data entry using the systems 100 and methods of BOI reporting may be performed manually (FIG. 5), such as by a professional service provider who is familiar with and understands the reporting requirements and rules under the Corporate Transparency Act (CTA) (FIG. 6). The present disclosure contemplates that many different types of machine learning and artificial intelligence may be employed by the machine learning and artificial intelligence systems and methods, and therefore, the one or more machine learning and artificial intelligence engines may include, but are not limited to, k-nearest neighbor (kNN), logistic regression, support vector machines or networks (SVM), linear regression, logistic regression, decision tree, naïve Bayes, K-Means, Random Forest, dimensionality reduction algorithms, gradient boosting algorithms (e.g., GBM, XGBoost, LightGBM, CatBoost), and/or more neural networks. Regardless, the use of machine learning and artificial intelligence in the framework and workflow of the present disclosure enhances the utility of analyzing missing, unknown, known, and/or collected data and its various components by automatically and heuristically constructing appropriate relationships, mathematical or otherwise, relative to the BOI final rules under the Corporate Transparency Act, BOI data or data sets, BOI data queries, BOI data input fields, business information, and owner information influencing follow-on outcomes for BOI reporting. The machine learning and artificial intelligence engine may be a cloud-based engine and may be associated with one or more databases. For example, the machine learning and artificial intelligence node may analyze, authenticate, and verify accuracy of BOI final rules under the Corporate Transparency Act, BOI data or data sets, BOI data queries, BOI data input fields, business (company applicant) information, and owner (business owner) information. Such analysis may be alone or performed in combination with one or more points of human inspection, such as by visual inspection and/or cross-referencing other BOI data queries and BOI data input fields. Business entity data collection 120 may also include, as shown by way of example in FIG. 5, as part of managing the business entity 118, auto-collecting one or more portions of the set of business entity details (Step 208, FIG. 10; Step 222, FIG. 11) via an autogenerated email 152 with one or more of the plurality of data input fields 154-160 having the corresponding BOI data queries 154-160 for any missing or unknown BOI information. Together or separately with auto-generated email data collection 152, an auto-generated instructional email 162 to an email recipient 176 (e.g., company applicant or owner of the business) may include instructions regarding FINCEN Identifier 164 and owner data entry 166. In one aspect of the systems and methods for BOI reporting, steps 208, 222 may include auto-collecting step (Step 208, FIG. 10; Step 222, FIG. 11) is accomplished without the email recipient 176 of the auto-generated email (e.g., company applicant or owner of the business or other company representative) having to create an account 160. For example, when managing the business entity 118, including tracking the entity 168, a user is entering information about individuals 170 and business entity 174 who will need to be reported on a BOI report, such as a beneficial owner or a company applicant (FIG. 7), BOI reporting systems and methods 100 (see also, for example, FIGS. 10-11) of the present disclosure provide options for data entry during business entity management 118 to include, for example, a user manually entering in system 100 all the required data/information about the owner/applicant or electing through business entity data collection 120 methods to auto-collect some or all of the required data/information (FIG. 5). In at least one scenario, this means the user of system 100 would select the type of BOIR report being filed and type in basic information like first and last name, email address, and phone number and an autogenerated email 152 would be sent to that individual where they would be presented with two options: 1) Enter their required information into the email form 154-160; or 2) Follow the directions provided in the auto-generated instructional email 162 to apply for a FinCEN identifier 164 where owner/applicant may submit their required information directly to FinCEN and provide the resulting unique identifying number in the autogenerated email collection form (FIG. 5). The autogenerated email 152, 162 that the beneficial owner or company applicant receives is in the form of a one-way data collection 156 process that is leak proof, requires no authentication 158, and does not require the email recipient (e.g., owner/applicant or other representative of the business entity) to create an account 160 for business entity data collection 120. At least one other aspect of the BOI reporting systems and methods 100 include the ability for the user of system 100 to enter partial information about the reporting owner/applicant, such as via manual entry. For example, if the user has the name, date of birth, and address of a beneficial owner/applicant of the business entity but is missing driver's license information, the user of system 100 may fill in the known information while auto collecting 120 (Step 208, FIG. 10; Step 222, FIG. 11) any missing or unknown information directly from the reporting owner/applicant (FIG. 5), or alternatively prompt the owner/applicant with an auto-generated instructional email 162 to obtain a FinCEN identifier 164 (FIG. 5) for managing business entity 118 by, at least in part, submitting one or more portions of the set of business entity details corresponding to any missing or unknown BOI information directly to FinCEN via business entity data collection 120 (FIG. 5). Once the completed BOI report has been sent to the signing owner to be e-signed and e-filed 144 (FIG. 9) the owner/applicant will be required to review the information that will be filed with FinCEN (FIG. 4). Records of the filing and filed BOI report may be provided to owner/applicant at that time in a downloadable version that will be a clean, easy-to-read format that the owner/applicant will be able to retain in their records.

In other aspects of the BOI reporting systems and methods 100 of the present disclosure, a representative of the business entity may start the BOI reporting process and be supported during manual entry using one or more active prompts for reporting fields based on the Corporate Transparency Act's rules to determine exemption status and identify reportable individuals, ensuring complete information for FinCEN filing (FIG. 2). BOI reporting systems and methods 100 provide for business entity data collection 120 tools configured for querying for the one or more types of BOI data via a plurality of data input fields having a corresponding BOI data query for collecting a set of business entity details pertaining to the company applicant or the owner of a business (Step 208, FIG. 10; Step 222, FIG. 11). The query process is logically backed by business entity data collection 120 (see, for example, FIGS. 2 & 5) and the final BOI rule under Corporate Transparency Act (CTA). Initial business entity management 118 querying is aimed at presenting a set of BOI data queries for determining if an owner/company applicant is exempt from the BOI reporting requirements. If no exemption is available, the query process presents additional sets of BOI data queries, applicable definitions, cross-references to pertinent sections of the final rules under the CTA, and examples that will intelligently assist, using one or more active prompts, in determining who needs to be reported on the BOI report. BOI reporting is completed, at least in part, by providing all information necessary to file the BOI report with FinCEN. Some representatives of the business entity (e.g., professional service providers) may understand exactly what information an owner/applicant of a business entity needs to be reported; however, instances may arise where a representative of the business entity does not know all the information or wants confirmation that they have all the information needed to be compliant. In this case, a representative of the business entity may utilize the BOI reporting systems and methods 100 of the present disclosure to ensure that they fully understand and/or obtain confirmation that they have everything needed to be compliant for filing a BOI report for their clients. BOI reporting information can also be manually entered (FIG. 4) by entering information for a business entity, without using the one or more BOI active data query prompts to aid in identifying who needs to be reported.

Upon completing the initial BOI report, a representative of the business entity (e.g., professional service provider) can either manage the filing themselves or opt to transfer (Step 210, FIG. 10; Step 224, FIG. 11) access controls 132-136, data ownership, billing, and administration 130 to another representative of the business entity (e.g., business owner or company applicant of business entity) for independently managing and submitting BOI reporting updates (FIG. 4), thereby offering users maximum flexibility in handling the stringent CTA updating 146 policies. For example, in at least one aspect according to the BOI reporting systems and methods 100 of the present disclosure, when a representative of the business entity (e.g., professional service provider) has completed and reviewed the initial BOI report for a reporting company owner/applicant, the representative of the business entity may send the BOI report for acceptance 140 and to be e-signed 144 by a signing owner (FIG. 4). At the start of the filing protocols 122, an option is provided, such as shown in FIG. 3, for a representative of the business entity (e.g., professional service provider) to choose, as part of an ownership transfer 124 (FIG. 7) to “hand-off” 126 or otherwise transfer all BOI reporting control to another representative of the business entity such as the company owner/applicant. From here, the other representative of the business entity (e.g., company owner/applicant or other representative) may take over management of their BOI report and be able to report and file any updates 146 (FIG. 4) independently using the BOI reporting systems and methods 100 of the present disclosure. For example, if a representative of the business entity is a professional service provider who chooses to transfer the entity to the reporting company owner/applicant, such transfer will result in the hand-off 126 of BOI data ownership, billing, and administration 130 from the professional service provider to the business owner/applicant (FIGS. 3 & 7-8). Alternatively, the professional service provider, acting as a representative of the business entity, can forgo transferring BOI data ownership, billing, and administration 130 and instead elect to provide a business owner/applicant white glove style service where the professional service provider takes on the required updating reporting obligations by managing and filing updates 146 under the CTA (FIG. 6) and acceptance 140, e-sign and filing 144 while managing the business entity 118. In the event the representative of the business entity, such as a professional service provider, wants the stringent updating requirements off their plate, then the BOI transfer systems and methods 100 of the present disclosure would provide the representative of the business entity with the ability to hand-off 126 by ownership transfer 124 (FIG. 7) BOI data ownership, billing, and administration 130 (FIGS. 3 & 7-8). Once BOI administrative controls have been handed-off/transferred, the transferee representative of the business entity, such as the business owners/applicants of the business entity, may restrict the professional service providers access to business owner/applicant information as part of the transfer controls 130-136.

Using the BOI reporting systems and methods 100 of the present disclosure, representatives of the business entity may also assist or continue to assist business owners/applicants with their ongoing BOI updating requirements under the CTA, even after ownership transfer 124 (FIG. 7) by handing-off 126/transferring administrative control 130 to the business owner/applicant. Representatives of the business entity may continue to have access to the BOI reporting systems and methods 100 of the present disclosure for a business owner/applicant such that the representative may assist or continue to assist the business owner/applicant with any of the ongoing updates or reporting details 146 (FIG. 4) required by FinCEN. However, anytime a representative of the business entity hands-off 126/transfers administrative control 130 to the business owner/applicant (FIG. 3), the business owner/applicant would be able to remove the representative of the business entity from being able to view some or all details about the reporting company and its owners based on controls 130-136.

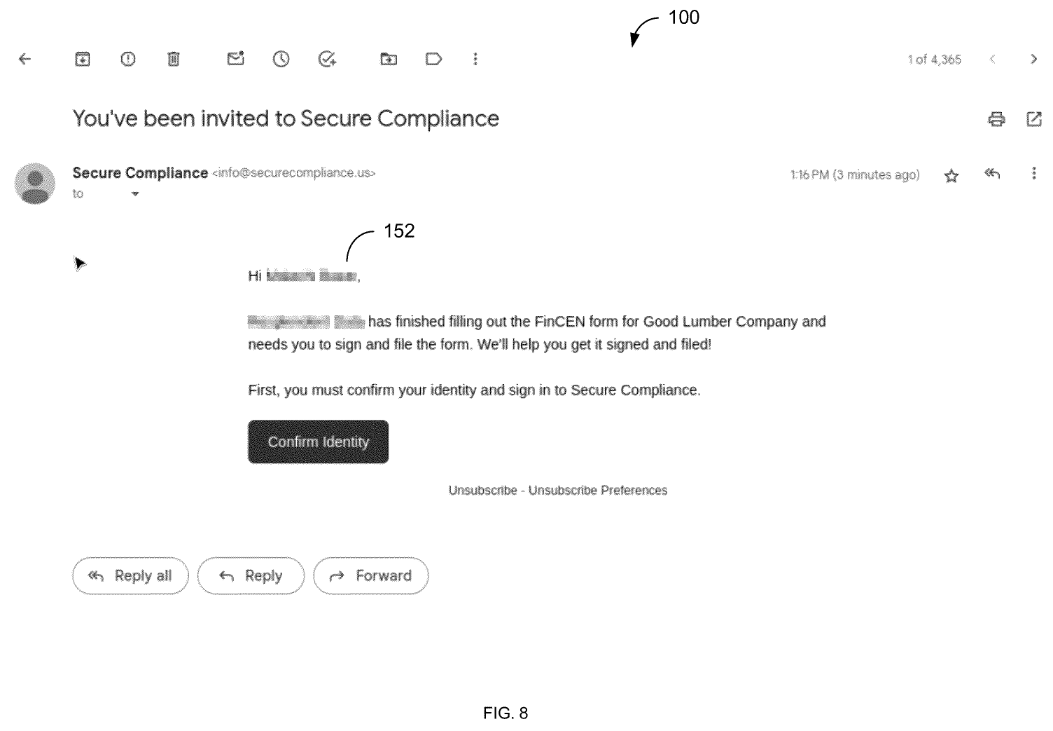

BOI reporting systems and methods 100 of the present disclosure provide tools for professional service providers to brand all email correspondence 152 (FIG. 8), including auto-generated emails and cover letters for e-filing, with their logos, trade dress, and trademarks to create a personalized and customized user experience. For example, auto-generated correspondence, such as an auto-generated email for BOI reporting data collection, can be branded and customized with logos, trade dress, and trademarks of the professional service providers' organization. In another example, cover letters that are sent upon initiation of the e-filing process may also be branded and customized with logos, trade dress, and trademarks of the professional service providers organization.

Business owners/applicants may independently file their initial BOI report using the BOI reporting systems and methods 100 of the present disclosure (FIG. 6). As indicated above, business owners/applicants start by assessing their exemption eligibility, and if exempt, they can download for their records a certificate detailing their responses, exemption type, relevant Corporate Transparency Act code, and criteria for the exemption. For example, when a business owner/applicant is independently filing their initial BOI report using the BOI reporting systems and methods 100 of present disclosure, they will begin the process by determining if they are exempt from the FinCEN reporting requirements. When the business owner/applicant answers questions that indicate their company is exempt from reporting, they can then download a certificate that outlines several details, including for example: 1) A record of their answers; 2) The exemption type; 3) The code from the Corporate Transparency Act under which the exemption is found; and 4) The requirements to meet the definition of that exemption.

The disclosure is not to be limited to the particular embodiments described herein. In particular, the disclosure contemplates numerous variations in Beneficial Ownership Information (BOI) reporting systems and methods. The foregoing description has been presented for purposes of illustration and description. It is not intended to be an exhaustive list or limit any of the present disclosure to the precise forms disclosed. It is contemplated that other alternatives or exemplary aspects are considered included in the disclosure. The description is merely examples of embodiments, processes, or methods of the disclosure. It is understood that any other modifications, substitutions, and/or additions can be made, which are within the intended spirit and scope of the disclosure.

What is claimed is:

1. A computer implemented method for Beneficial Ownership Information (BOI) reporting with Financial Crime Enforcement Network (FinCEN), comprising:
providing a cloud-based system for managing, collecting and filing one or more types of BOI data for a business entity;
accessing the cloud-based system with a computer system, displaying on a screen of the computer system one or more webpages of the cloud-based system, and executing with the computer system the cloud-based system processes of:
receiving registration details for the business entity from a representative of the business entity;
electing a management protocol for the one or more types of BOI data from a set of management elections;
querying for the one or more types of BOI data via a plurality of data input fields having a corresponding BOI data query for collecting a set of business entity details pertaining to the business entity;
optionally transferring the management protocol from the representative to another representative of the business entity;
preparing a BOI report; and
filing the BOI report with FinCEN.

2. The computer implemented method of claim 1, further comprising:
accepting payment for filing the BOI report with FinCEN.

3. The computer implemented method of claim 1, wherein the representative of the business entity comprises: (1) a professional service provider; (2) a beneficial owner or a company applicant; or (3) a business entity representative that is not from groups (1) or (2).

4. The computer implemented method of claim 1, wherein the transferring the management protocol step further comprises:
transferring data ownership, billing, and administration from a professional service provider representative to a beneficial owner representative of the business entity or a company applicant representative of the business entity.

5. The computer implemented method of claim 1, further comprising:
initiating one or more machine learning or artificial intelligence protocols during the step of querying for the one or more types of BOI data via the plurality of data input fields having the corresponding BOI data query for collecting the set of business entity details pertaining to the company applicant or the owner of the business.

6. The computer implemented method of claim 1, wherein the step of collecting the set of business entity details pertaining to the business entity further comprises:
auto-collecting one or more portions of the set of business entity details via an autogenerated email with one or more of the plurality of data input fields having the corresponding BOI data query for any missing or unknown BOI information.

7. The computer implemented method of claim 1, wherein the step of collecting the set of business entity details pertaining to the business entity further comprises:
auto-generating an email to the representative of the business entity with instructions for obtaining a FinCEN identifier and submitting directly to FinCEN one or more portions of the set of business entity details corresponding to any missing or unknown BOI information.

8. A computer implemented system for Beneficial Ownership Information (BOI) reporting with Financial Crime Enforcement Network (FinCEN), comprising:
a cloud-based system for managing, collecting and filing one or more types of BOI data for a business entity;
a tangible computer readable medium comprising computer executable instructions tangibly embodied thereon which, when executed, cause a processor of a computer system to access the cloud-based system with the computer system, display on a screen of the computer system one or more webpages of the cloud-based system, and execute with the computer system the cloud-based system of:
a registration webpage for receiving registration details for the business entity from a representative of the business entity;
an ownership management webpage for electing a management protocol for the one or more types of BOI data from a set of management elections;
one or more BOI data query webpages comprising a plurality of data input fields having a corresponding BOI data query for collecting a set of business entity details pertaining to the business entity; and
one or more BOI report submission webpages for filing the BOI report with FinCEN.

9. The computer implemented system of claim 8, further comprising:
one or more payment processing webpages for filing the BOI report with FinCEN.

10. The computer implemented system of claim 8, wherein the ownership page includes an option for transferring the management protocol from the representative to another representative of the business entity.

11. The computer implemented system of claim 8, wherein the ownership management webpage further comprises:
one or more selections for transferring data ownership, billing, and administration from a professional service provider representative to a beneficial owner representative of the business entity or a company applicant representative of the business entity.

12. The computer implemented system of claim 8, further comprises:
an auto-collecting email generation webpage for collecting one or more portions of the set of business entity details with one or more of the plurality of data input fields having the corresponding BOI data query for any missing or unknown BOI information.

13. The computer implemented system of claim 8, further comprises:
an auto-collecting email generation webpage for generating an email to the representative of the business entity with instructions for obtaining a FinCEN identifier and submitting directly to FinCEN one or more portions of the set of business entity details corresponding to any missing or unknown BOI information.

14. A tangible computer readable storage medium comprising computer executable instructions tangibly embodied thereon which, when executed, cause a processor of a computer system to access a cloud-based system with the computer system, display on a screen of the computer system one or more webpages of the cloud-based system, and execute with the computer system the cloud-based system of managing, collecting and filing one or more types of BOI data for a business entity, the method comprising:
receiving registration details for the business entity;
electing a management protocol for the one or more types of BOI data from a set of management elections;
querying for the one or more types of BOI data via a plurality of data input fields having a corresponding BOI data query for collecting a set of business entity details pertaining to the business entity;
preparing a BOI report; and
filing the BOI report with FinCEN.

15. The method of claim 14, further comprising:
optionally transferring the management protocol from the representative to another representative of the business entity.

16. The method of claim 14, further comprising:
accepting payment for filing the BOI report with FinCEN.

17. The method of claim 14, further comprising:
managing a set of decision protocols for the corresponding BOI data query with one or more active context prompts on a business entity management webpage.

18. The method of claim 15, wherein the transferring the management protocol step further comprises:
transferring data ownership, billing, and administration from a professional service provider representative to: (1) an owner representative of the business entity; (2) a company applicant representative of the business entity; or (3) another representative of the business entity that is not a representative from groups (1) or (2).

19. The computer implemented method of claim 14, wherein the step of collecting the set of business entity details pertaining to the business entity further comprises:
auto-collecting one or more portions of the set of business entity details via an autogenerated email with one or more of the plurality of data input fields having the corresponding BOI data query for any missing or unknown BOI information, wherein the auto-collecting step is accomplished without an email recipient of the autogenerated email having to create an account.

20. The computer implemented method of claim 14, wherein the step of collecting the set of business entity details pertaining to the business entity further comprises:
auto-generating an email to the representative of the business entity with instructions for obtaining a FinCEN identifier and submitting directly to FinCEN one or more portions of the set of business entity details corresponding to any missing or unknown BOI information.
